(19) United States
(12) Patent Application Publication
(10) Pub. No.: US 2011/0035222 A1
(43) Pub. Date: Feb. 10, 2011

(54) SELECTING FROM A PLURALITY OF AUDIO CLIPS FOR ANNOUNCING MEDIA

(75) Inventor: Jon Schiller, San Ramon, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/534,980

(22) Filed: Aug. 4, 2009

(51) Int. Cl. G10L 13/08; G06F 3/01; G06F 3/16

(52) U.S. Cl. 704/260; 715/716; 715/727; 704/E13.001

(57) ABSTRACT

Systems and methods for selecting one of several audio clips associated with a text item for playback are provided. The electronic device can determine which audio clip to play back at any point in time using different approaches, including for example receiving a user selection or randomly selecting audio clips. In some embodiments, the electronic device can intelligently select audio clips based on attributes of the media item, the electronic device operations, or the environment of the electronic device. The attributes can include, for example, metadata values of the media item, the type of ongoing operations of the electronic device, and environmental characteristics that can be measured or detected using sensors of or coupled to the electronic device. Different audio clips can be associated with particular attribute values, such that an audio clip corresponding to the detected or received attribute values are played back.

### FIELD OF THE INVENTION

This relates to selecting one of several audio clips for announcing a media item available for playback by an electronic device. In particular, this relates to selecting one of several audio clips all providing the same message using different voices or sounds based on the context of the electronic device.

### BACKGROUND OF THE DISCLOSURE

Today, many popular electronic devices, such as personal digital assistants (“PDAs”) and hand-held media players or portable electronic devices (“PEDs”), are battery powered and include various user interface components. Conventionally, such portable electronic devices include buttons, dials, or touchpads to control the media devices and to allow users to navigate through media assets, including, for example, music, speech, or other audio, movies, photographs, interactive art, text, and media resident on (or accessible through) the media devices, to select media assets to be played or displayed, and/or to set user preferences for use by the media devices. The functionality supported by such portable electronic devices is increasing. At the same time, these media devices continue to get smaller and more portable. Consequently, as such devices get smaller while supporting robust functionality, there are increasing difficulties in providing adequate user interfaces for the portable electronic devices.

Some user interfaces have taken the form of graphical user interfaces or displays which, when coupled with other interface components on the device, allow users to navigate and select media assets and/or set user preferences. However, such graphical user interfaces or displays may be inconvenient, small, or unusable. Other devices have completely done away with a graphical user display. To enhance a user's ability to interact with such devices, the devices can provide audio clips describing operations performed by the device, the status of the device, or other suitable information. The audio clips can be generated using any suitable approach, including for example a text-to-speech engine or pre-recorded strings by human voices.

Typically, a device may have a single audio clip for each operation, instruction or media item of the device. In some embodiments, the device can include a single audio clip of an artist name, song title, and album name, for example generated using a text to speech engine, or pre-recorded by an actor. Only a limited number of audio clips, however, may be available for playback, and in particular only a single audio clip for each text item or content for which audio feedback is required.

### SUMMARY OF THE DISCLOSURE

This is directed to selecting from several available audio clips for providing audio feedback for particular text items. In particular, this is directed to selecting one of several audio clips for providing audio feedback for a single text item, where each of the several audio clips includes the text item.

An electronic device can include different contexts in which an audio clip is to be provided. For example, an audio clip can be provided to describe operations that the user can control (e.g., menu options from a graphical or audio menu). As another example, audio clips can be provided to identify media being played back, or scheduled for playback by the device (e.g., announce tracks in response to a user instruction). For consistency, all of the audio clips played back by the device can be generated using the same voice (e.g., the same text-to-speech voice or actor voice).

In some cases, however, a user may wish to use different types of audio clips at different times for announcing a same event (e.g., audio clips corresponding to a same or similar text item or content). For example, a user can have audio clips defining track titles, album names, and artist names that are generated by a text-to-speech engine, as well as additional audio clips recorded by the artist, celebrities, actors in a music video, or other voices of interest to the user. In one implementation, each member of a band can record audio clips for each track in an album. In some embodiments, a user can purchase audio clips for announcing tracks that are recorded by the artist of the track (e.g., to personalize a playlist). In such cases, the electronic device can have several different audio clips for announcing the same events. In some embodiments, the several audio clips can each speak or include the same or substantially the same text item (e.g., several audio clips saying a band name).

When several audio clips are available for announcing a single event, the electronic device can use different approaches for selecting one of the audio clips. In some embodiments, the electronic device can receive a user selection of a particular audio clip to play back (e.g., use an audio clip identified using a host device when the media item is first selected to be transferred to the electronic device). In some embodiments, the electronic device can instead randomly pick an audio clip, or play back each of the audio clips is succession, each time the event for which the audio clip is to played back occurs (e.g., cycle through the artist name audio clips as different media items by the artist are played back).

In some embodiments, the electronic device can instead or in addition select one of the several audio clips based on the context of the event for which the audio clip is required. For example, the electronic device can select a particular audio clip based on an attribute of the media item to be played back. The attribute can include, for example, the BPM of the media, audio pitch, volume, album name, genre, year, rating, chart ranking, or any other attribute of a media item. As another example, the electronic device can select a particular audio clip based on the collection of media items being played back. In particular, the electronic device can select an audio clip based on the current playlist media items, attributes of the playlist (e.g., when the playlist was created, the type of playlist, the genre of the media in the playlist, the playlist rating, whether the playlist is published, or the order of the playlist in a series of playlists), the previously played back media item or media items, the next media item or media items, or any other attribute associated with the collection of media items being played back.

In some embodiments, the electronic device can instead or in addition select an audio clip based on the environment of the user or of the electronic device. For example, using one or more sensors, the electronic device can monitor and the user's environment or the user's condition. Criteria derived from the user's environment can include, for example, ambient light, ambient noise, the location of the device, the proximity to other devices (e.g., the number of other devices detected in a communications network), attributes of the user (e.g., the user's current mood), or other detectable criteria derived from the user's environment.

### BRIEF DESCRIPTION OF THE DRAWINGS

The above and other embodiments of the invention will be apparent upon consideration of the following detailed description, taken in conjunction with accompanying drawings, in which like reference characters refer to like parts throughout, and in which:

FIG. 1 is a schematic view of an illustrative electronic device for playing back audio clips in accordance with one embodiment of the invention;

FIG. 2 is a schematic view of an illustrative display for selecting an audio to play back for a particular media item in accordance with one embodiment of the invention;

FIG. 3 is a schematic view of an illustrative display for selecting an audio to play back for a particular media item in accordance with one embodiment of the invention; and

FIG. 4 is a flowchart of an illustrative process for selecting an audio clip for playback in accordance with one embodiment of the invention.

### DETAILED DESCRIPTION OF THE DISCLOSURE

This relates to systems and methods for selecting one from several audio clips associated with the same content for playback by an electronic device. Using an electronic device, a user may play back audio clips announcing media items being played back, scheduled for playback, or available for playback. The audio clips can include any suitable information, including for example audio corresponding to a text item or other content. In some embodiments, the text items can include text corresponding to metadata associated with media items, including for example an artist name, media item title, album, genre, or any other metadata for a media item.

In some embodiments, several audio clips may be available for a single text item. For example, an electronic device can include several audio clips generated using different voices or accents of a text to speech engine. As another example, an electronic device can include several audio clips generated by recording different people speak the text item. Any suitable person or voice type can be selected to generate recorded audio clips. In one implementation, celebrities can be used to generate audio clips. Alternatively or in addition, artists involved in a particular media item can record audio clips of text items related to the media item. For example, band members can record audio clips of text items relating to songs written or performed by the band. As another example, actors can record audio clips of text items relating to tv shows, movies, music videos, or other videos in which the actor takes part.

The electronic device can select which of several audio clips to play back using any suitable approach. In some embodiments, the user can direct an audio clip for playback. In some embodiments, the electronic device can instead randomly select an audio clip, or cycle through the available audio clips each time an audio clip for the text item is provided. In some embodiments, the electronic device can instead or in addition select an audio clip based on an attribute of a media item being played back. For example, the electronic device can select an audio clip based on an attribute (e.g., metadata) of the played back media, media playlist, past or future media, or any other suitable media item. In some embodiments, the electronic device can select an audio clip based on an attribute of the environment of the electronic device playing back the media. The electronic device can detect any suitable environmental attribute, or environment criteria.

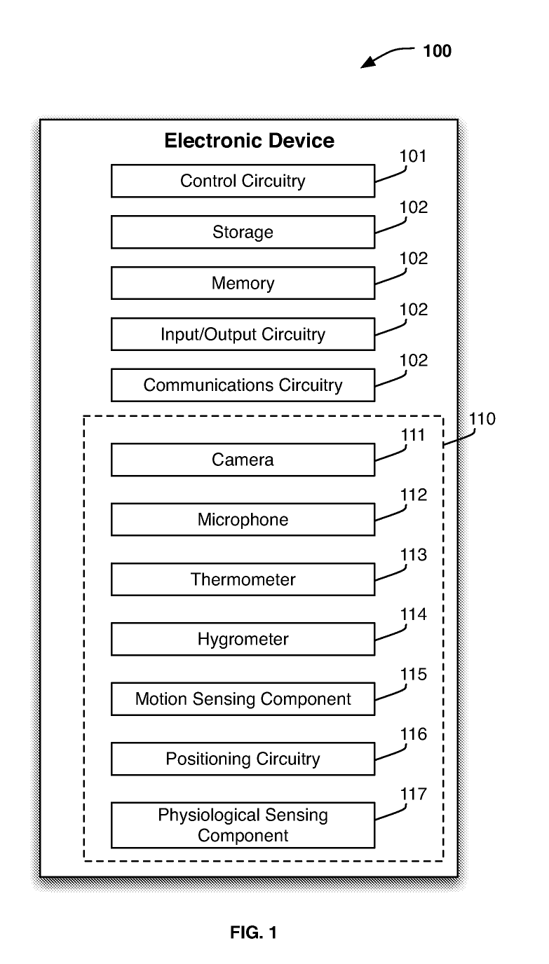

FIG. 1 is a schematic view of an illustrative electronic device for playing back audio clips in accordance with one embodiment of the invention. Electronic device 100 can include control circuitry 101, storage 102, memory 103, input/output circuitry 104, communications circuitry 105, and one or more sensors 110. In some embodiments, one or more of the components of electronic device 100 can be combined or omitted. For example, storage 102 and memory 103 can be combined into a single mechanism for storing data. In some embodiments, electronic device 100 can include other components not combined or included in those shown in FIG. 1, such as a power supply (e.g., a battery or kinetics), a display, a bus, or an input interface. In some embodiments, electronic device 100 can include several instances of the components shown in FIG. 1 but, for the sake of simplicity, only one of each of the components is shown in FIG. 1.

Electronic device 100 can include any suitable type of electronic device operative to provide music. For example, electronic device 100 can include a media player such as an iPod® available by Apple Inc., of Cupertino, Calif., a cellular telephone, a personal e-mail or messaging device, an iPhone® available from Apple Inc., pocket-sized personal computers, personal digital assistants (PDAs), a laptop computer, a music recorder, a video recorder, a camera, and any other suitable electronic device. In some cases, electronic device 100 can perform a single function (e.g., a device dedicated to playing music) and in other cases, electronic device 100 can perform multiple functions (e.g., a device that plays music, displays video, stores pictures, and receives and transmits telephone calls).

Control circuitry 101 can include any processing circuitry or processor operative to control the operations and performance of an electronic device of the type of electronic device 100. Storage 102 and memory 103, which can be combined can include, for example, one or more storage mediums or memory used in an electronic device of the type of electronic device 100. In particular, storage 102 and memory 103 can store information related to monitoring an environment such as signals received from a sensor or another device or a characteristic property of the environment derived from a received signal. Input/output circuitry 104 can be operative to convert (and encode/decode, if necessary) analog signals and other signals into digital data, for example in any manner typical of an electronic device of the type of electronic device 100. Electronic device 100 can include any suitable mechanism or component for allowing a user to provide inputs to input/output circuitry 104, and any suitable circuitry for providing outputs to a user (e.g., audio output circuitry or display circuitry).

Communications circuitry 105 can include any suitable communications circuitry operative to connect to a communications network and to transmit communications (e.g., voice or data) from device 100 to other devices within the communications network. Communications circuitry 105 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, FTP, RTP, RTSP, SSH, Voice over IP (VOIP), any other communications protocol, or any combination thereof. In some embodiments, communications circuitry 105 can be operative to provide wired communications paths for electronic device 100.

In some embodiments, communications circuitry 105 can interface electronic device 100 with an external device or sensor for monitoring an environment. For example, communications circuitry 105 can interface electronic device 100 with a network of cameras for monitoring an environment. In another example, communications circuitry 105 can interface electronic device 100 with a motion sensor attached to or incorporated within a user's body or clothing (e.g., a motion sensor similar to the sensor from the Nike+iPod Sport Kit sold by Apple Inc. of Cupertino, Calif. and Nike Inc. of Beaverton, Oreg.).

Sensors 110 can include any suitable circuitry or sensor for monitoring an environment. For example, sensors 110 can include one or more sensors integrated into a device that can monitor the device's environment. Sensors 110 can include, for example, camera 111, microphone 112, thermometer 113, hygrometer 114, motion sensing component 115, positioning circuitry 116, and physiological sensing component 117.

Camera 111 can be operative to detect light in an environment. In some embodiments, camera 111 can be operative to detect the average intensity or color of ambient light in an environment. In some embodiments, camera 111 can be operative to detect visible movement in an environment (e.g., the collective movement of a crowd). In some embodiments, camera 111 can be operative to capture digital images. Camera 111 can include any suitable type of sensor for detecting light in an environment. In some embodiments, camera 111 can include a lens and one or more sensors that generate electrical signals. The sensors of camera 111 can be provided on a charge-coupled device (CCD) integrated circuit, for example. Camera 111 can include dedicated image processing circuitry for converting signals from one or more sensors to a digital format. Camera 111 can also include circuitry for pre-processing digital images before they are transmitted to other circuitry within device 100.

Microphone 112 can be operative to detect sound in an environment. In some embodiments, microphone 112 can be operative to detect the level of ambient sound (e.g., crowd noise) in an environment. In some embodiments, microphone 112 can be operative to detect a crowd's noise level. Microphone 112 can include any suitable type of sensor for detecting sound in an environment. For example, microphone 112 can be a dynamic microphone, condenser microphone, piezoelectric microphone, MEMS (Micro Electro Mechanical System) microphone, or any other suitable type of microphone.

Thermometer 113 can be operative to detect temperature in an environment. In some embodiments, thermometer 113 can be operative to detect the air temperature of an environment. Thermometer 113 can include any suitable type of sensor for detecting temperature in an environment.

Hygrometer 114 can be operative to detect humidity in an environment. In some embodiments, hygrometer 114 can be operative to detect the relative humidity of an environment. Hygrometer 114 can include any suitable type of sensor for detecting humidity in an environment.

Motion sensing component 115 can be operative to detect movements of electronic device 100. In some embodiments, motion sensing component 115 can be operative to detect movements of device 100 with sufficient precision to detect vibrations in the device's environment. In some embodiments, the magnitude or frequency of such vibrations may be representative of the movement of people in the environment. For example, each person may be dancing and their footfalls may create vibrations detectable by motion sensing component 115. Motion sensing component 115 can include any suitable type of sensor for detecting the movement of device 100. In some embodiments, motion sensing component 115 can include one or more three-axes acceleration motion sensing components (e.g., an accelerometer) operative to detect linear acceleration in three directions (i.e., the x or left/right direction, the y or up/down direction, and the z or forward/backward direction). As another example, motion sensing component 115 can include one or more two-axis acceleration motion sensing components which can be operative to detect linear acceleration only along each of x or left/right and y or up/down directions (or any other pair of directions). In some embodiments, motion sensing component 115 can include an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

Positioning circuitry 116 can be operative to determine the current position of electronic device 100. In some embodiments, positioning circuitry 116 can be operative to update the current position at any suitable rate, including at relatively high rates to provide an estimation of movement (e.g., speed and distance traveled). Positioning circuitry 116 can include any suitable sensor for detecting the position of device 100. In some embodiments, positioning circuitry 116 can include a global positioning system (“GPS”) receiver for accessing a GPS application function call that returns the geographic coordinates (i.e., the geographic location) of the device. The geographic coordinates can be fundamentally, alternatively, or additionally derived from any suitable trilateration or triangulation technique. For example, the device can determine its location using various measurements (e.g., signal-to-noise ratio (“SNR”) or signal strength) of a network signal (e.g., a cellular telephone network signal) associated with the device. For example, a radio frequency (“RF”) triangulation detector or sensor integrated with or connected to the electronic device can determine the approximate location of the device. The device's approximate location can be determined based on various measurements of the device's own network signal, such as: (1) the angle of the signal's approach to or from one or more cellular towers, (2) the amount of time for the signal to reach one or more cellular towers or the user's device, (3) the strength of the signal when it reaches one or more towers or the user's device, or any combination of the aforementioned measurements, for example. Other forms of wireless-assisted GPS (sometimes referred to herein as enhanced GPS or A-GPS) can also be used to determine the current position of electronic device 100. Instead or in addition, positioning circuitry 116 can determine the location of the device based on a wireless network or access point that is in range or a wireless network or access point to which the device is currently connected. For example, because wireless networks have a finite range, a network that is in range of the device can indicate that the device is located in the approximate geographic location of the wireless network.

Physiological sensing component 117 can be operative to detect one or more physiological metrics of a user. In some embodiments, physiological sensing component 117 may be operative to detect one or more physiological metrics of a user operating device 100. Physiological sensing component 117 can include any suitable sensor for detecting a physiological metric of a user. Physiological sensing component 117 can include a sensor operative to detect a user's heart rate, pulse waveform, breathing rate, blood-oxygen content, galvanic skin response, temperature, heat flux, any other suitable physiological metric, or any combination thereof. For example, physiological sensing component 117 can include a heart rate sensor, a pulse waveform sensor, a respiration sensor, a galvanic skin response sensor, a temperature sensor (e.g., an infrared photodetector), an optical sensor (e.g., a visible or infrared light source and photodetector), any other suitable physiological sensor, or any combination thereof. In some embodiments, physiological sensing component 117 may include one or more electrical contacts for electrically coupling with a user's body. Such sensors can be exposed to the external environment or disposed under an electrically, optically, and/or thermally conductive material so that the contact can obtain physiological signals through the material. A more detailed description of suitable components for detecting physiological metrics with electronic devices can be found in U.S. patent application Ser. No. 11/729,075, entitled “Integrated Sensors for Tracking Performance Metrics” and filed on Mar. 27, 2007, which is incorporated by reference herein in its entirety.

While the embodiment shown in FIG. 1 includes camera 111, microphone 112, thermometer 113, hygrometer 114, motion sensing component 115, positioning circuitry 116, and physiological sensing component 117; it is understood that any other suitable sensor or circuitry can be included in sensors 110. For example, sensors 110 may include a magnetometer or a proximity sensor in some embodiments.

The electronic device can play back audio clips at any appropriate time. For example, the electronic device can play back audio clips announcing or identifying media items available for playback, or electronic device operations to be performed. The audio clips can correspond to text items, such that the audio clips can serve as a spoken menu. The audio clips can be generated using any suitable manner. In some embodiments, the audio clips can be generated using a text-to-speech engine. Using the engine, a voice can be applied to a text string to generate a spoken clip. The electronic device can generate the audio clips directly with a built-in text-to-speech engine, or can instead or in addition receive audio clips generated by a remote text-to-speech engine (e.g., located in a host device or in a remote server).

In some embodiments, the electronic device can instead or in addition include audio clips of recordings created by people reading text items. Any suitable person can create an audio clip, including for example the user, friends or acquaintances of the user, or famous or well-known people. For example, celebrities can record audio clips. As another example, people related to a media item can record audio clips for text items related to the media item. In one implementation, an artist or band members can record audio clips of the artist or band name, media item names, album names, genres, or other metadata text items that relate to media items associated with the artist or band. For example, the individual band members of the band U2 (i.e., Bono, the Edge, Adam Clayton and Larry Mullen) can record the band name, track names, and album name for an album that they have recorded. As another example, an actor or person appearing in a video (e.g., in a movie or tv show) can record audio clips of text items relating to the video (e.g., video title, comments, date).

Audio clips can be generated for any text item or content that relates to a media item. In particular, an audio clip can be generated for any information describing, identifying, or otherwise related to or associated with a media item available for playback by an electronic device. In one implementation, audio clips can be generated for some or all of the metadata that is associated with a media item or a collection of media items (e.g., an album, series, or collection). For example, audio clips can be generated based on the artist, album, title, composer, time, genre, year, rating, description, grouping, compilation, playlist, beats per minute (BPM), comments, play count, codec, lyrics, show, or any other metadata field. In some embodiments, audio clips may be generated for text items that relate to media items but are not metadata associated with the media items.

The electronic device can retrieve audio clips for media items using any suitable approach. In some embodiments, a user can purchase audio clips recorded by particular people, or generated by a particular voice using a text-to-speech engine (e.g., using an online music store such as the iTunes® music store available from Apple Inc.). The audio clips can be purchased with or independently from media items. In some embodiments, the audio clips can be bundled with individual media tracks or with albums or collections of media tracks (e.g., audio clips recorded by band members are included with a purchase of an album by the band). The user can purchase or acquire any suitable number of audio clips for a particular text item, including more than one. For example, a user can acquire audio clips recorded by 4 different band members, a text-to-speech engine generated audio clip, and a user-created recording for the same text item (e.g., artist name).

When several audio clips are available for a particular text item, the electronic device may be required to pick one of the audio clips to play back when it is time to announce the text item. The electronic device can use any suitable strategy for selecting one of the several available audio clips. For example, the electronic device can pick an audio clip at random. As another example, the electronic device can use a default audio clip (e.g., use a purchased audio clip, if it exists, and otherwise use a text-to-speech engine generated clip). As still another example, the electronic device can cycle through the available audio clips.

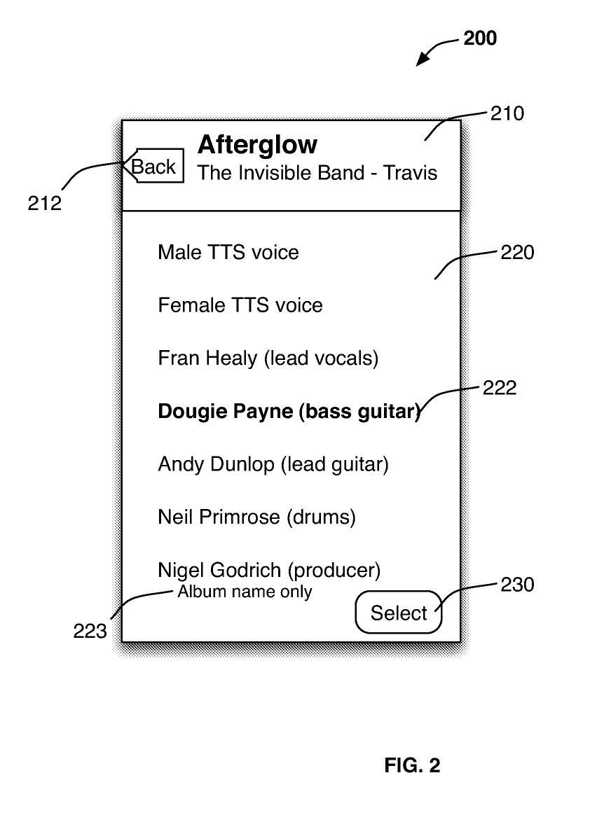

In some embodiments, the user can select a particular audio clip to use for a media item or playlist. For example, the user can assign a particular audio clip for a media item or collection of media items. As another example, the user can select a particular attribute of audio clips, and associate the attribute with a media item or a collection of media items. The electronic device can then identify the audio clip attribute associated with the media item or collection of media items being played, identify the audio clip associated with the identified attribute, and play back the identified audio clip. The user can associate audio clips with media items using any suitable approach. Although the following discussion will be in the context of a single media item, it will be understood, however, that the described embodiments can be applied to any collection of media items (e.g., playlists). FIG. 2 is a schematic view of an illustrative display for selecting an audio to play back for a particular media item in accordance with one embodiment of the invention. Display 200 can include identifying information 210 identifying a particular media item available for playback. The user can select the particular media item identified by information 210 using any suitable approach, including for example by selecting the media item from a listing (e.g., a listing from a navigation menu). The user can return to the previous listing or menu by selecting back option 212. Identifying information 210 can include any suitable information for identifying a media item. For example, the identifying information can include a title, album and artist name, or other text identifying the media item (e.g., a show name, actor or artist names, or source information such as a television channel). In some embodiments, the information can instead or in addition include an image (e.g., a screenshot, illustrative video frame, or cover art).

Display 200 can include listings 220 of available audio clips associated with the identified media item. Each listing of listings 220 can identify an audio clip using any suitable approach, including for example based on an attribute or metadata of the audio clip. In the example shown in display 200, each listing is identified by the voice used to generate the audio clip. The listing can include a description of the voice, for example to specify who the voice is (e.g., identifying particular band members by their instruments). Each listing can be annotated to specify the particular text items for which audio clips are available (e.g., annotation 223), for example when audio clips are available for only some of the text items associated with the media item (e.g., a particular person only recorded audio clips for an album name).

The user can select a listing to preview an audio clip. The electronic device can identify a listing as being selected using any suitable approach, including for example a highlight region, changing the color, font or pattern of the listing, or any other suitable approach. As shown in display 200, listing 222 is selected. The user can then associate the audio clip of a particular selected listing with the media item, for example by selection option 230.

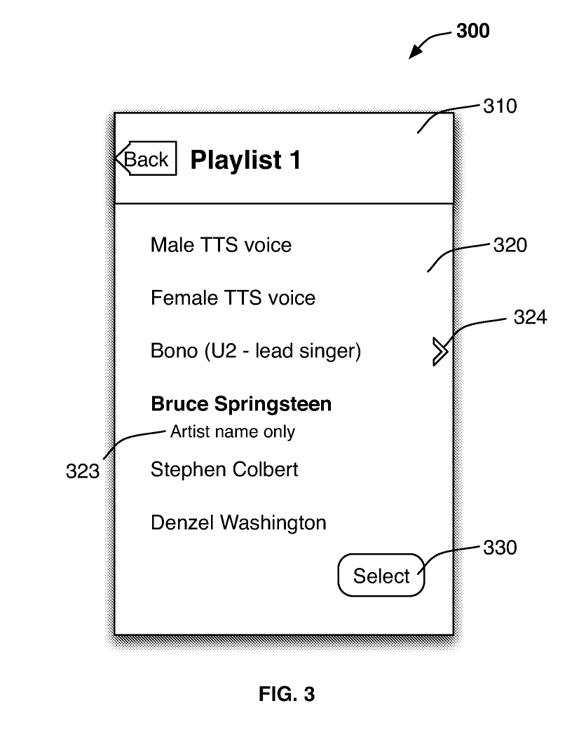

In some embodiments, the user can associate a particular type of audio clip with a collection of media items. FIG. 3 is a schematic view of an illustrative display for selecting an audio to play back for a particular media item in accordance with one embodiment of the invention. Display 300 can include identifying information 310 and listings 320, which can include some or all of the features described above in connection with the corresponding sections of display 200 (FIG. 2). Identifying information 310 can identify any suitable collection of media items, including for example a playlist (e.g., identify a playlist name), an album (e.g., identify album and artist names), a compilation (e.g., identify a compilation name, media items in the compilation, or common characteristics of the media items in the compilation), or other collections of media items.

Listings 320 can include any suitable listing of audio clips available for the selected collection of media items. The audio clips can be identified in any suitable manner, including for example by the voice associated with the clip, the text item or type of text item of the audio clip (e.g., artist name), the number of text items for which audio clips are available, or any other suitable identifying information. Listings 320 can specify the text items for which the audio clips are available using any suitable approach, including for example by identifying text items as part of the listing (e.g., annotation 323). In some embodiments, the user can select a particular listing (e.g., of a voice) to view a secondary listing of the text items for which audio clips are available with the selected voice. Listings for which a listing of text items are available can be identified in any suitable manner, including for example by chevron 324. In some embodiments, listings for audio clips can only be displayed for audio clips for which at least a particular number of media items in the collection are associated with the audio clips (e.g., a particular %, or a minimum number of media items). If a voice is selected for which no audio clip is available for a particular text item, the electronic device can use a default voice for the particular text item (e.g., a text-to-speech voice).

Similar to display 200, the user can select a listing from listings 320 to preview an audio clip (e.g., preview an audio clip for a particular text string spoken with the voice identified by the listing). The electronic device can identify a listing as being selected using any suitable approach, including for example a highlight region, changing the color, font or pattern of the listing, or any other suitable approach. The user can then associate the audio clip of a particular selected listing with the collection of media items, for example by selection option 330.

In some embodiments, the electronic device can instead or in addition automatically select one of several audio clips associated with a text item to play back. The electronic device can use any suitable approach for selecting one of the audio clips. In some embodiments, each audio clip or collection of audio clips can be associated with a metadata value or value range, or a characteristic of media items. For example, audio clips associated with a particular voice can be associated with media items for which the artist name starts with the letter “B.” As another example, audio clips associated with a particular voice can be associated with media items for which the beats per minute are in the range of 120 to 140. Audio clips can be associated with any suitable characteristic of media items, including for example characteristics for which metadata is associated with media items. Such characteristics can include, for example, artist name, title, album name, tv show, movie, series composer, time, genre, year, rating, description, grouping, beats per minute (BPM), comments, play count, codec, lyrics, playlist, or any other suitable metadata field or characteristic.

Because a particular media item or collection of media items can include different metadata, each of which can be associated with different collections of audio clips, the electronic device may include a ranking system for different metadata types or metadata values. For example, the electronic device can rank metadata based on its relative importance to a user (e.g., title, artist, album, and then the remaining metadata in alphabetical order). In such an implementation, the electronic device can first identify the metadata value associated with the title, and determine whether an audio clip is associated with the title value. If an associated audio clip is identified, the electronic device can playback the identified audio clip. If no associated audio clip is found, the electronic device can identify the metadata value associated with the next most important metadata category, and identify the audio clip associated with the newly identified metadata value. If no audio clip is associated with any metadata values of a media item, the electronic device can use a default audio clip. In some embodiments, different values of a particular metadata type can be associated with different priorities (e.g., artist names starting in “B” have a high priority, but artist names starting in “V” have a low priority).

In some embodiments, the electronic device can cycle through a limited number of audio clips based on the metadata or characteristics of the media items being played back. For example, the electronic device can associate a subset of the several audio clips with a particular metadata value, and cycle through the subset of audio clips each time an audio clip is to be played back (e.g., cycle through the audio clips of the band members naming the artist and the songs of an album as the songs of the album are played back).

In some embodiments, the electronic device can review a collection of media items selected for playback (e.g., an album or a playlist), and select a particular set of audio clips that is appropriate for the collection. For example, the electronic device can review the collection, and identify a common voice for audio clips associated with the media items of the collection. As another example, the electronic device can identify a set of audio clips that exist for at least a minimum number of the media items in the collection (e.g., the electronic device has audio clips recorded by a particular person for the text items associated with at least 75% of the media items in the collection). As still another example, the electronic device can identify the set of audio clips (e.g., audio clips recorded by the same person) that are associated with the largest number of media items in the collection. In some embodiments, the electronic device can instead or in addition select several sets of audio clips (e.g., several collections of audio clips recorded by different people) to provide audio feedback for some, most or all of the media items in the collection. The electronic device can use a default voice or default set of audio clips for the media items with which no audio clips in the selected set are associated.

In some embodiments, the electronic device can instead or in addition select the audio clips to play back based on attributes of the environment or of the user that are detected by the device. The device can use any suitable sensor or combination of sensors to detect environmental attributes, including for example the sensors described in electronic device 100 (FIG. 1). In some embodiments, each audio clip or collection of audio clips (e.g., all audio clips recorded with the same voice) can be associated with an environment attribute value or value range, or a characteristic of the environment. For example, audio clips associated with a particular voice can be associated with media items played back when the exterior temperature is in the range of 70 to 85 degrees. As another example, audio clips associated with a particular voice can be associated with media items played back when the user's mood is determined to be “sad.” Audio clips can be associated with any suitable attribute of the environment or of the user that the electronic device can detect or infer from the user's interactions with the device. Such attributes can include, for example the ambient light, detected color palette of the environment (e.g., of the user's clothing, or of the location of the user), ambient sound, sound emitted by the user (e.g., particular words spoken by the user, the volume of words spoken by the user, or sounds caused by the user's movements or actions), ambient temperature, the user's temperature, the environment humidity, device movement, device location, device orientation (e.g., as detected by a compass or magnometer), the user's or another person's physiological condition (e.g., the user's temperature, heart rate, pulse waveform, breathing rate, blood-oxygen content, galvanic skin response, or heat flux), the user's mood (e.g., extrapolated from different sensor outputs), or any other suitable environmental attribute.

Similar to the discussion above, a particular media item can be played back at a time when different environmental attributes can be detected and measured, each of which may be associated with different audio clips. The electronic device can then prioritize the environmental attributes and environmental attribute values to select one or more sets of audio clips to play back for a particular media item. In addition, the electronic device can cycle through one or more sets of audio clips for a particular text item. Other features discussed above in the context of media item attribute-based selection of audio clips can be applied to the environment attribute0based selection of audio clips.

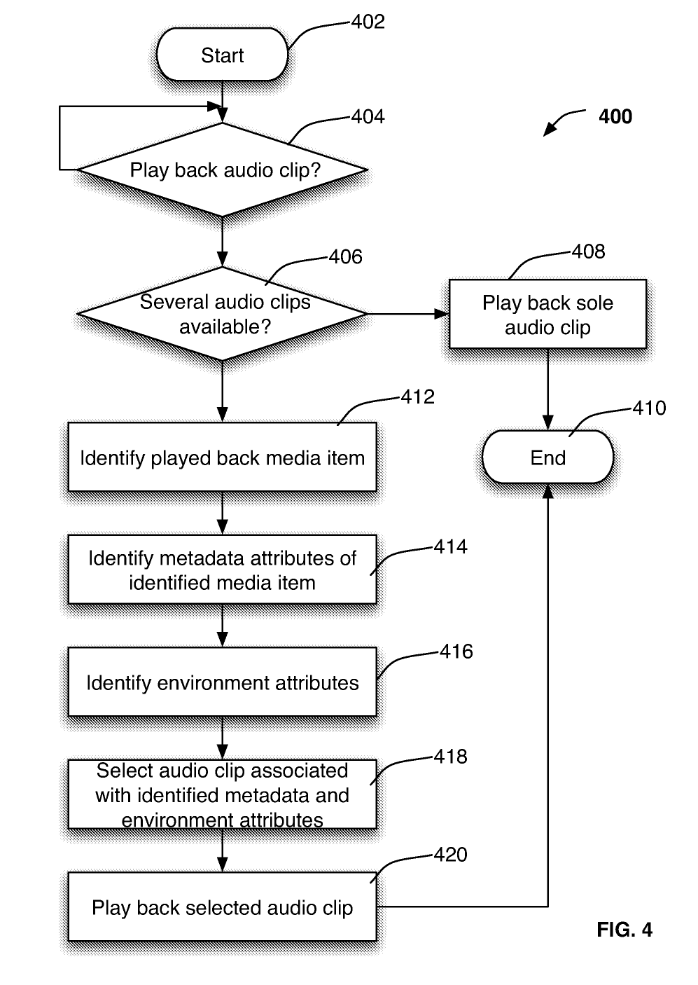

FIG. 4 is a flowchart of an illustrative process for selecting an audio clip for playback in accordance with one embodiment of the invention. Process 400 may begin at step 402. At step 404, the electronic device can determine whether to play back an audio clip. For example, the electronic device can determine whether the current operation is associated with an audio clip playback. As another example, the electronic device can determine whether a user has requested an audio clip to be played back (e.g., to identify a media item). If the electronic device determines that no audio clip should be played back, process 400 can return to step 404 and continue to monitor for clip playback instructions If, at step 404, the electronic device instead determines that a clip is to be played back, process 400 can move to step 406.

At step 406, the electronic device can determine whether several different audio clips are available for playback for the operation or instruction identified at step 404. For example, the electronic device can determine whether several audio clips associated with the same text item (e.g., an artist name) are available. If the electronic device determines that only one audio clip is available, process 400 can move to step 408. At step 408, the electronic device can play back the single available audio clip, and end at step 410.

If, at step 406, the electronic device instead determines that several audio clips are available, process 400 can move to step 412. At step 412, the electronic device can identify a played back media item. For example, the electronic device can identify the previously played back media item, next media item to be played back, or currently played back media item. In some embodiments, the electronic device can instead or in addition identify the collection of media items currently being played back (e.g., the current playlist or album). At step 414, the electronic device can identify metadata attributes of the identified media item. For example, the electronic device can determine characteristics of the media item. At step 416, the electronic device can identify environment attributes for the environment of the electronic device. The environment attributes can include, for example, attributes or characteristics of the environment detected by sensors of the electronic device, received from external sensors or other devices, or attributes of characteristics of the user of the device.

At step 418, the electronic device can select an audio clip associated with the identified metadata and environment attributes. For example, the electronic device can prioritize the identified attributes, and select the audio clip associated with the most important attribute. As another example, the electronic device can select the audio clip associated with the largest number of identified attributes. As still another example, the electronic device can select the audio clip associated with the highest weighed average of the identified attributes (e.g., where more important attributes or attribute values are more heavily weighed). At step 420, the electronic device can play back the selected audio clip. Process 400 can then end at step 420.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the present invention are presented for purposes of illustration and not of limitation, and the present invention is limited only by the claims which follow.

What is claimed is:

1. A method for selecting one from a plurality of audio clips each associated with the same content, comprising:
determining that a plurality of audio clips corresponding to particular content are available;
identifying characteristics of a media item selected for playback;
selecting one of the plurality of audio clips based on the identified characteristics; and
playing back the selected one of the plurality of audio clips.

2. The method of claim 1, wherein identifying further comprises identifying characteristics of at least one of:
a previously played back media item;
a currently played back media item; and
a media item scheduled for playback in the future.

3. The method of claim 1, wherein identifying further comprises:
identifying characteristics of a collection of media items selected for playback.

4. The method of claim 1, wherein the characteristics comprise at least one of:
artist;
title;
album;
composer;
tv show;
movie;
series;
duration;
genre;
year;
rating;
description;
playlist;
compilation;
beats per minute;
comments;
play count;
codec; and
lyrics.

5. The method of claim 1, wherein:
each of the plurality of audio clips is associated with a particular characteristic.

6. The method of claim 5, further comprising:
identifying the subset of the plurality of audio clips associated with the identified characteristics of the media item;
prioritizing the identified characteristics; and
selecting one of the subset of the plurality of audio clips based on the prioritization of the identified characteristics.

7. The method of claim 6, further comprising:
selecting several of the subset of the audio clips based on the prioritization; and
cycling playback through the selected several of the subset of audio clips.

8. The method of claim 1, wherein:
the plurality of audio clips are associated with the same text item.

9. The method of claim 8, wherein the plurality of audio clips comprise at least one of:
recordings of a person saying the text item; and
an audio clip generated by applying a text-to-speech engine to the text item.

10. An electronic device operative to play back audio clips to announce media items available for playback, comprising audio output circuitry and control circuitry, the control circuitry operative to:
identify a media item being played back by the playback circuitry;
identify a text item for which an audio clip is to be played back;
determine that a plurality of audio clips correspond to the identified text item;
select one of the plurality of audio clips based on attributes of the identified media item; and
direct the audio output circuitry to play back the selected one of the plurality of audio clips.

11. The electronic device of claim 10, wherein the control circuitry is further operative to:
retrieve associations of audio clips with attributes of the identified media item; and
identify the audio clip associated with the most attributes of the identified media item.

12. The electronic device of claim 10, wherein the control circuitry is further operative to:
retrieve associations of audio clips with attributes of the identified media item;
weigh the attributes; and
identify the audio clip associated with the highest weighed average of the attributes.

13. The electronic device of claim 10, wherein the control circuitry is further operative to:
identify a collection of media items available for playback;
identify the plurality of audio clips associated with the identified collection of media items; and
select a set of the plurality of audio clips, wherein the set of plurality of audio clips share similar audio properties and correspond to different text items.

14. The electronic device of claim 13, wherein:
the selected set of plurality of audio clips have the same voice speaking different text items.

15. The electronic device of claim 14, wherein:
the voice used for the set of plurality of audio clips is at least one of a recorded person's voice and a voice from a text-to-speech engine.

16. The electronic device of claim 10, wherein the control circuitry is further operative to:
direct the audio output circuitry to play back an audio clip announcing at least one of:
a currently played back media item;
a currently played back collection of media items;
a collection of media items available for playback; and
the future media item scheduled for playback.

17. A method for selecting one of a plurality of audio clips to play back for announcing a media item, comprising:
identifying a media item for which an audio clip is to be played back, the audio clip corresponding to a text item;
determining that a plurality of audio clips corresponding to the text item are available;
detecting an attribute of the environment; and
selecting one of the plurality of audio clips for playback based on the detected attribute of the environment.

18. The method of claim 17, further comprising:
retrieving an association of environment attribute values and audio clips; and
selecting an audio clip associated with at least a minimum number of detected environment attribute values.

19. The method of claim 18, further comprising:
weighing the relative importance of the detected environment attribute values; and
selecting an audio clip based on the weighed importance of the detected environment attribute values.

20. The method of claim 17, wherein the detected attributes of the environment comprise at least one of:
ambient light;
a detected color palette of the environment;
ambient sound;
sound emitted by a user;
ambient temperature;
humidity;
device movement;
device location;
device orientation;
a user's temperature;
a user's heart rate;
a user's pulse waveform;
a user's breathing rate;
a user's blood-oxygen content;
a user's galvanic skin response;
a user's heat flux; and
a user's mood.

21. Computer readable media for selecting one from a plurality of audio clips each associated with the same content, the computer readable media comprising computer readable instructions recorded thereon for:
determining that a plurality of audio clips corresponding to particular content are available;
identifying characteristics of a media item selected for playback;
selecting one of the plurality of audio clips based on the identified characteristics; and
playing back the selected one of the plurality of audio clips.
